(19) United States
(12) Patent Application Publication
(10) Pub. No.: US 2022/0166117 A1
(43) Pub. Date: May 26, 2022

(54) Cover Assembly for a Cell Housing of a Prismatic Battery Cell With Connection Contacts for a Heating Device, Battery Cell and High-Voltage Battery

(71) Applicant: Bayerische Motoren Werke Aktiengesellschaft, Muenchen (DE)

(72) Inventors: Ruediger DAUB, Groebenzell (DE); Niclas EMRICH, Muenchen (DE); Simon LUX, Muenchen (DE); Seokyoon YOO, Baldham (DE)

(21) Appl. No.: 17/425,752

(22) PCT Filed: Apr. 24, 2020
(86) PCT No.: PCT/EP2020/061433

§ 371 Date: Jul. 26, 2021

(30) Foreign Application Priority Data
May 24, 2019 (DE) 10 2019 113 914.7

(51) Int. Cl. H01M 50/553; H01M 50/51; H01M 10/615; H01M 10/6571; H01M 10/647

(52) U.S. Cl. CPC H01M 50/553; H01M 50/51; H01M 10/647; H01M 10/6571; H01M 10/615

(57) ABSTRACT

A cover assembly for a cell housing of a prismatic battery cell for a high-voltage battery includes two cell terminals for electrically connecting to a respective cell-external connection and to a respective electrode of a galvanic element of the battery cell, and a cover plate for covering the cell housing having two through-openings for the cell terminals. At least one of the cell terminals is overmoulded with an electrically insulating plastic for retaining same on the cover plate, and additional electrical connection contacts for a cell-internal heating device for heating the galvanic element are guided through the through-opening for the at least one cell terminal, the additional electrical connection contacts being overmoulded with the electrically insulating plastic for electrically insulating same from the cell terminal and the cover plate.

### BACKGROUND AND SUMMARY OF THE INVENTION

The invention relates to a cover assembly for a cell housing of a prismatic battery cell of a high-voltage battery. The cover assembly comprises two cell terminals for electrical connection to a respective cell-external connection and for electrical connection to a respective electrode of a galvanic element of the battery cell. The cover assembly furthermore comprises a cover plate for covering the cell housing, the cover plate having two through-openings for the cell terminals. The invention further relates to a battery cell, to a high-voltage battery and to a motor vehicle.

In the present case, the focus is on high-voltage batteries or high-voltage rechargeable batteries, in particular for electrically driveable motor vehicles. High-voltage batteries of this kind have a plurality of battery cells, which are usually arranged in a cell assembly and interconnected to form a battery module. The battery cells can be prismatic battery cells, which have a flat-cuboidal cell housing, in the interior of which a galvanic element is arranged. Electrodes of the galvanic element are electrically connected to cell terminals of the battery cell, the cell terminals being guided through a cover plate of the cell housing and via which the battery cell can be electrically connected to a cell-external connection, for example a cell terminal of another battery cell.

In this case, as the operating temperature of the battery cell decreases, a maximum power that can be provided by the battery cell generally decreases. In the case of an electrically driveable motor vehicle, this can lead at low external temperatures at the beginning of a journey to only a limited drive power and a limited charging power being available. It is therefore known from the prior art to equip battery cells with a heating device so that the galvanic element can be heated when required. It is also known to form the heating device as a cell-internal heating system, in which at least one heating element is arranged together with the galvanic element in the interior of the cell housing.

However, the problem here is the contact-connection of the heating element. Usually, connection contacts of the heating elements are guided through separate through-openings in a wall of the cell housing for this purpose. However, this is associated with considerable outlay in the production of the battery cell, since the through-openings first have to be provided in the cell housing and, after the connection contacts have been guided through, have to be sealed.

It is the object of the present invention to be able to contact-connect a cell-internal heating device of a battery cell for a high-voltage battery in a particularly simple manner.

This object is achieved according to the invention by way of a cover assembly, a battery cell and a high-voltage battery having the features according to the claimed invention.

A cover assembly according to embodiments of the invention for a cell housing of a prismatic battery cell of a high-voltage battery has two cell terminals for electrical connection to a respective cell-external connection and for electrical connection to a respective electrode of a galvanic element of the battery cell. The cover assembly furthermore has a cover plate for covering the cell housing, the cover plate having two through-openings for the cell terminals. At least one of the cell terminals is overmolded with an electrically insulating plastic for retaining the at least one cell terminal on the cover plate. Moreover, additionally electrical connection contacts for a cell-internal heating device for heating the galvanic element are guided through the through-opening for the at least one cell terminal, the additional electrical connection contacts being overmolded with the electrically insulating plastic for electrical insulation from the cell terminal and the cover plate.

Embodiments of the invention furthermore include a prismatic battery cell for a high-voltage battery, which has a galvanic element and a heating device with connection contacts and at least one heating element for heating the galvanic element. The battery cell furthermore comprises a cell housing, in the interior of which the galvanic element and the at least one heating element of the heating device are arranged and which has a cover assembly according to embodiments of the invention. Connection contacts of the heating device that are guided via the through-opening out of the interior of the cell housing are accessible from outside.

The cover assembly and a housing bottom part, which may consist of a base plate and a housing casing, form the cell housing for the prismatic battery cell. In this case, the cover plate and the housing bottom part enclose an interior for the galvanic element of the battery cell. The cover plate and the base plate are designed in particular as rectangular, plate-like elements, with the result that a flat-cuboidal cell housing is formed. In this case, the cell housing is formed in particular from a metallic material, for example aluminum. The cover plate has two through-openings for the two cell terminals. The cell terminals are thus guided through the cover plate by virtue of them being arranged, in areas, in the through-opening. A first cell terminal can be electrically connected to a first electrode, for example an anode, of the galvanic element and a second cell terminal can be electrically connected to a second electrode, for example a cathode, of the galvanic element.

Furthermore, the connection contacts for connection to the at least one heating element of the heating device are guided through at least one of the through-openings, in particular through exactly one of the through-openings. The connection contacts are thus likewise guided through the cover plate out of the interior of the cell housing in which the at least one heating element is arranged so as to form a cell-internal heating system for the galvanic element. The connection contacts thus concomitantly use the through-opening of at least one of the cell terminals.

In order to retain the cell terminals on the cover plate and at the same time to seal the through-opening, the cell terminals are overmolded with a plastic, for example in an injection molding process. This plastic, which is still liquid during the injection molding, can flow in gaps between an edge of the through-openings and the respective cell terminal and between the cell terminal and the cover plate and connect the cell terminal and the cover plate in a materially bonded manner. It is thus possible to produce a particularly tight connection between the cover plate and the cell terminal by way of the plastic. A particularly tight connection should be understood as, in particular, a connection that is at least tight with respect to a helium leak. Therefore, a battery cell with a particularly long service life for a high-voltage battery, in particular for application in a motor vehicle, can be provided.

In order to prevent the electrically conductive cell terminal, the electrically conductive cell housing and the electrically conductive connection contacts of the heating device from being short-circuited here, at least the cell terminal whose through-opening is concomitantly used by the connection contacts is overmolded by the electrically insulating plastic. For this purpose, for example to carry out the injection molding process, the connection contacts, the cover plate and the cell terminal are inserted into an injection molding tool in a predetermined position relative to one another and the plastic is injected into gaps between the connection contacts, the cover plate and the cell terminal. As soon as the plastic is cured, the connection contacts, the cover plate and the cell terminal remain in the predetermined position relative to one another and in the process are electrically insulated from one another.

The plastic used can in this case be a thermoplastic or an elastomer or a thermosetting plastic. A plastic in the form of a thermosetting plastic is preferably used. Thermosetting plastics are plastics that can no longer be deformed by heating or other measures after they have been cured. Thermosetting plastics are furthermore particularly cost-effective and have a good temperature resistance.

By introducing the connection contacts into the injection molding process, it is possible to provide contact-connection for the cell-internal heating system with few method steps. Furthermore, separate through-openings, which also have to be sealed in a complex manner, for the connection contacts do not have to be provided in the cell housing.

Preferably, a first cell terminal is overmolded by an electrically insulating plastic and a second cell terminal is overmolded by an electrically conductive plastic. For example, the anode-side cell terminal is overmolded by the electrically insulating plastic while the cathode-side cell terminal is overmolded by the electrically conductive plastic. As a result, the anode-side cell terminal is electrically insulated from the cell housing while the cathode-side cell terminal is at the potential of the cell housing.

Particularly preferably, the two cell terminals each have a plate-like first section for electrical connection to the cell-external connection and a second section, connected to the first section, for electrical connection to the electrode of the galvanic element. The cell terminals are arranged on the cover plate in such a way that the second section is arranged in the respective through-opening and the first section and a top side of the cover plate overlap. In at least one of the cell terminals, the connection contacts for the heating device are inserted into an intermediate space between the second section and the cover plate and between an edge of the through-opening and the second section. The electrically insulating plastic is injected into this intermediate space. Each cell terminal is formed for example monolithically or in one piece and has a cross section substantially in the shape of a T-piece, wherein the first section is of plate-like design and the second section is of web-like design. The second section is arranged on a bottom side of the first section. In the state in which the cell terminal is arranged on the cover plate, the first section thus extends parallel to the top side of the cover plate and is arranged at a distance from the cover plate. The second section is designed to project from the first section and protrudes into the interior of the cell housing. In this case, the second section is guided through the through-opening and arranged at a distance from the edge of the through-opening. The intermediate space between the cover plate and the cell terminal thus has an L-shaped cross-section. In the case of at least one of the cell terminals, the connection contacts are inserted into this intermediate space for connection to the at least one heating element of the heating device. The electrically insulating plastic injected into the intermediate space surrounds the connection contacts.

Provision can also be made for the plastic to be arranged on the cover assembly in such a way that it furthermore also covers a bottom side of the cover plate. In other words, after the plastic has been injected, the plastic layer forms not only an L-shaped fold bending at the through-opening, but is extended to form a U-shaped fold or overlay, which also adheres at least in regions to the bottom side of the cover plate. A particularly tight connection between the cover plate and the cell terminal can thus be produced by way of the plastic.

In order to improve the adhesion between the plastic and the cell terminal and between the plastic and the cover plate, for example the surface regions of the cell terminal and of the cover plate facing toward the intermediate space can be provided with a surface structure having structural elements. The structural elements have in particular dimensions in the nanometer or micrometer range and can be designed, for example, as pores, capillaries, cuts, projections and/or undercuts. For example, the structural elements can be produced by way of a laser. When the plastic is injected into the intermediate space, the plastic, which is still liquid at this point, flows via the structural elements and is connected to them also in a positively locking manner when the plastic solidifies or is cured. By structuring the relevant surface regions of the cell terminal and of the cover plate, it is possible to omit, in particular, further joining components, such as adhesive or the like, since the plastic and the relevant surface regions form a particularly stable, effective and whole-area connection.

In an advantageous development of the invention, the connection contacts are electrically conductive, flexible connection lugs. The connection lugs can thus be bent or folded in an L-shaped manner in order, for example, to be inserted into the intermediate space with the L-shaped cross section. The connection lugs can be mechanically connected to one another, for example via an electrically insulating, flexible ribbon. Connection pads, which are electrically connected to the connection lugs and can be electrically connected to connections of the at least one heating element, can be arranged on this ribbon. The connection contacts can be integrated into the injection molding process in a particularly simple manner by connecting the connection lugs by way of the electrically insulating ribbon.

In a development of the cover plate, this is of rectangular design and has two narrow sides and two long sides, wherein a first connection contact in the form of a feeder is guided out of the intermediate space in the region of a first long side and a second connection contact in the form of a deflector is guided out of the intermediate space in the region of a second long side. For example, a heating current is fed to the at least one heating element via the feeder and removed again from same via the deflector. The connection contacts are thus guided out of the intermediate space at two opposite sides of the cover plate and are therefore accessible in the region of the long sides. In the case of prismatic battery cells stacked alongside one another, the connection contacts can be connected in a particularly simple manner in order to connect the heating devices of the battery cells in series, for example.

In a development of the battery cell, the heating device has a heating film as the at least one heating element, the heating film being electrically connected to the connection contacts. In particular, the galvanic element is formed as an arrangement of electrode films and separator films. The at least one heating film is integrated into the arrangement. For example, the arrangement of electrode films, separator films and the at least one heating film can be a film stack. In this case, the heating films can have a heating wire or heating resistor, which runs in a meandering manner, is connected to the connection contacts and to which a heating current for heating the galvanic element is fed via the connection contacts.

The invention furthermore relates to a high-voltage battery having a plurality of prismatic battery cells according to the invention stacked to form a cell stack. The high-voltage battery is preferably designed as a traction battery for an electrically driveable motor vehicle. In particular, the heating devices of the battery cells are connected in series by electrically connecting the connection contacts of two adjacent battery cells. By connecting the heating device in series, contact-connection of the heating devices to an energy source providing the heating current is particularly simple and can be carried out, for example, by the connection contacts of the first and last battery cell in the cell stack.

The embodiments presented with respect to the cover assembly according to the invention and the advantages thereof apply accordingly to the battery cell according to the invention and to the high-voltage battery according to the invention.

Further features of the invention emerge from the claims, the figures and the description of the figures. The features and combinations of features mentioned above in the description and the features and combinations of features shown below in the description of the figures and/or shown in the figures alone can be used not only in the respectively stated combination, but also in other combinations or alone.

The invention is now explained in more detail on the basis of a preferred example embodiment and with reference to the drawings.

### BRIEF DESCRIPTION OF THE DRAWINGS

FIG. 1 shows a schematic exploded illustration of an embodiment of a battery cell according to the invention.

FIG. 2 shows a schematic sectional illustration of the cover assembly.

FIG. 3 shows a schematic illustration of a cover assembly of the battery cell.

FIG. 4 shows a schematic illustration of an embodiment of a high-voltage battery according to the invention.

### DETAILED DESCRIPTION OF THE DRAWINGS

Identical and functionally identical elements are provided with the same reference signs in the figures.

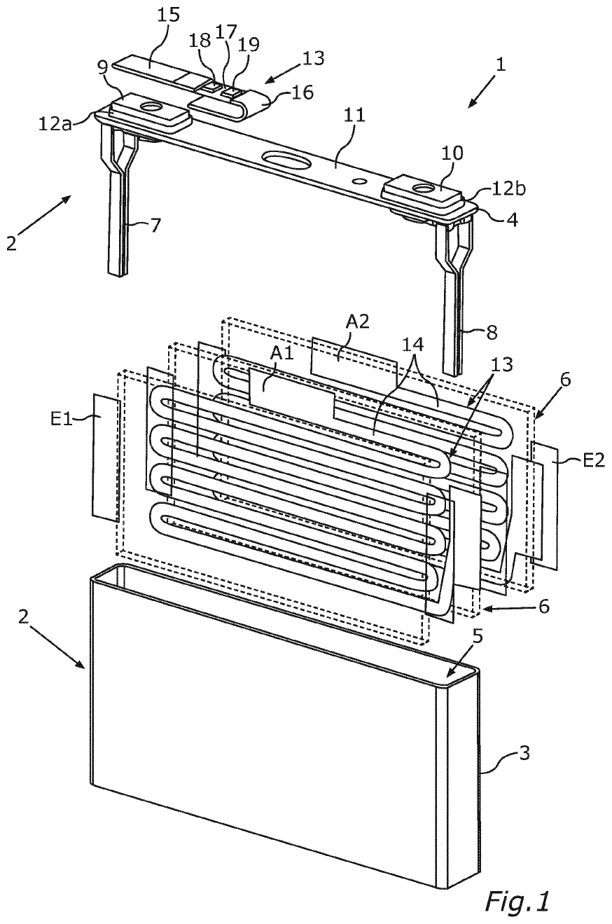

FIG. 1 shows an exploded illustration of a prismatic battery cell 1. The battery cell 1 has a cell housing 2 having a housing bottom part 3 and a cover assembly 4. The cell housing 2 is formed from metal, for example aluminum. The cell housing 2 surrounds an interior 5 for receiving a galvanic element 6 of the battery cell 1. In this case, the galvanic element 6 has a stack arrangement of electrode films and separator films impregnated with electrolyte. Electrodes E1 and E2 of the galvanic element 6 are connected to cell terminals 9, 10 of the battery cell 1 via deflectors 7, 8. A first cell terminal 9 is designed as an anode-side cell terminal and connected to a first electrode El in the form of an anode of the galvanic element 6 via a first deflector 7. A second cell terminal 10 is designed as a cathode-side cell terminal and connected to a second electrode E2 in the form of a cathode of the galvanic element 6 via a second deflector 8. The cell terminals 9, 10 are integrated into a cover plate 11 of the cover assembly 4. For this purpose, the cell terminals 9, 10 are guided through the cover plate 11 and overmolded with a plastic 12a, 12b. For example, the anode-side terminal 9 is overmolded with a plastic 12a composed of an electrically insulating material while the cathode-side cell terminal 10 is overmolded with a plastic 12b composed of electrically conductive material. The cathode-side cell terminal 10 is thus at a potential of the cell housing 2.

The battery cell 1 furthermore has a heating device 13 for heating the galvanic element 6. For example, the heating device 13 has a heating resistor 14, which is integrated into the electrode film/separator film arrangement of the galvanic element 6. The heating device 13 furthermore has two connection contacts 15, 16, which are designed as electrically conductive, flexible or bendable connection lugs. In this case, the connection lugs are connected by a flexible ribbon 17 composed of an electrically insulating material, on which connection pads 18, 19 are arranged. The first connection contact 15 is connected here to a first connection A1 of the heating resistor 14 via the first connection pad 18 and the second connection contact 16 is connected here to a second connection A2 of the heating resistor 14 via the second connection pad 19. A heating current for heating the galvanic element 6 can be fed to the heating resistor 14 via the connection contacts 15, 16.

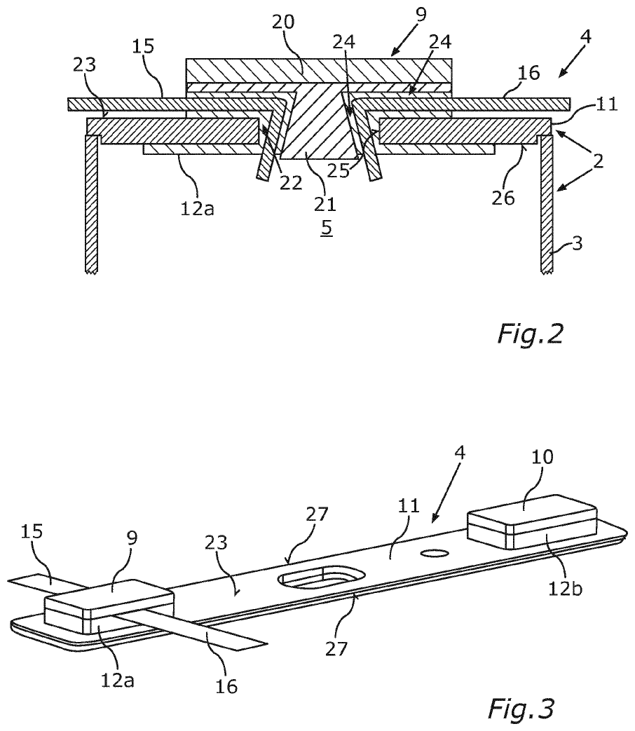

The connection contacts 15, 16 are in this case, as shown in FIG. 2, guided out of the cell housing 2 together with at least one of the cell terminals 9, 10, in this case the cell terminal 9, which is overmolded by the electrically insulating plastic 12a. The cell terminals 9, 10 have a first, plate-like section 20 for connection to a cell-external connection and a second section 21 for connection to one of the electrodes, in this case the first electrode El, of the galvanic element 6. A through-opening 22, into which the second section 21 is plugged, is arranged in the cover plate 11. The first section 20 is designed to be overlapping with a top side 23 of the cover plate 11. The connection contacts 15, 16 are guided through an intermediate space 24, which is formed between the first section 20 and the top side 23 of the cover plate 11 and between an edge 25 of the through-opening 22. The intermediate space 24 has an L-shaped cross section. The connection contacts 15, 16 are bent in an L-shaped manner so that they are guided out of the interior 5 of the cell housing 2 to the outside.

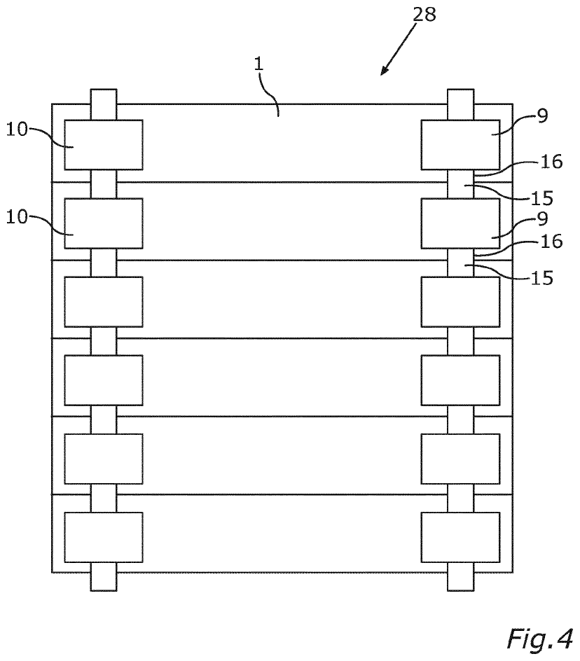

The plastic 12a composed of the electrically insulating material is furthermore injected into this intermediate space 24. By way of the plastic 12a, on the one hand the cell terminal 9 is retained on the cover plate 11 and on the other hand the connection contacts 15, 16 are electrically insulated from the cell terminal 9 and the cover plate 11. The plastic 12a is furthermore arranged in this case in regions on a bottom side 26 of the cover plate 11 in order to seal the through-opening 22. On the basis of the illustration of the cover assembly 4 according to FIG. 3, it is clear that the connection contacts 15, 16 are guided out of the intermediate space 24 in the region of two opposite long sides 27 of the cover plate 11. It is thus possible to interconnect in series the heating devices 13 of a plurality of battery cells 1 of a high-voltage battery 28, the battery cells being stacked alongside one another, in a particularly simple manner as is shown in FIG. 4.

1.-10. (canceled)

11. A cover assembly for a cell housing of a prismatic battery cell for a high-voltage battery, the cover assembly comprising:
two cell terminals for electrical connection to a respective cell-external connection and for electrical connection to a respective electrode of a galvanic element of the prismatic battery cell; and
a cover plate for covering the cell housing, the cover plate having two through-openings for the cell terminals; wherein:
at least one of the cell terminals is overmolded with an electrically insulating plastic for retaining the at least one cell terminal on the cover plate, and
electrical connection contacts for a cell-internal heating device for heating the galvanic element are guided through the through-opening for the at least one cell terminal, the electrical connection contacts being overmolded with the electrically insulating plastic for electrical insulation from the cell terminal and the cover plate.

12. The cover assembly according to claim 11, wherein:
each of the two cell terminals has a plate-like first section for electrical connection to the cell-external connection and a second section, connected to the first section, for electrical connection to the electrode of the galvanic element,
each of the two cell terminals are arranged on the cover plate such that the second section is arranged in the respective through-opening and the first section and a top side of the cover plate overlap, and
in at least one of the cell terminals, the electrical connection contacts are inserted in an intermediate space between the second section and the cover plate and between an edge of the through-opening and the second section, and the electrically insulating plastic is injected into the intermediate space.

13. The cover assembly according to claim 11, wherein:
a first one of the cell terminals is overmolded by an electrically insulating plastic and a second one of the cell terminals is overmolded by an electrically conductive plastic.

14. The cover assembly according to claim 12, wherein:
the cover plate has a rectangular shape with two narrow sides and two long sides,
a first one of the electrical connection contacts in a form of a feeder is guided out of the intermediate space in a region of a first one of the long sides, and
a second one of the electrical connection contacts in a form of a deflector is guided out of the intermediate space in a region of a second one of the long sides.

15. The cover assembly according to claim 11, wherein:
the electrical connection contacts are electrically conductive, and flexible connection lugs.

16. A prismatic battery cell comprising:
a galvanic element;
a heating device having electrical connection contacts and at least one heating element for heating the galvanic element; and
a cell housing, wherein:
the galvanic element and the at least one heating element of the heating device are arranged in an interior of the cell housing,
the cell housing has a cover assembly according to claim 11, and
the electrical connection contacts of the heating device are guided via the through-opening out of the interior of the cell housing and are accessible from outside.

17. The prismatic battery cell according to claim 16, wherein:
the heating device has a heating film as the at least one heating element, and
the heating film is electrically connected to the electrical connection contacts.

18. The prismatic battery cell according to claim 17, wherein:
the galvanic element is formed as an arrangement of electrode films and separator films, and
the heating film is integrated into the arrangement.

19. A high-voltage battery comprising:
a plurality of prismatic battery cells according to claim 16, wherein the plurality of prismatic battery cells are stacked to form a cell stack.

20. The high-voltage battery according to claim 19, wherein:
the heating devices of the prismatic battery cells are connected in series by electrically connecting the electrical connection contacts of two adjacent prismatic battery cells.
